(19) United States
(12) Patent Application Publication
(10) Pub. No.: US 2009/0138279 A1
(43) Pub. Date: May 28, 2009

(54) SYSTEMS, METHODS AND APPARATUS FOR ANALYSIS AND VISUALIZATION OF METADATA INFORMATION

(75) Inventors: Gopal B. Avinash, New Berlin, WI (US); Saad Ahmed Sirohey, Pewaukee, WI (US); Rakesh Mohan Lal, Plano, TX (US)

Correspondence Address: DEAN D. SMALL;THE SMALL PATENT LAW GROUP LLP, 225 S. MERAMEC, STE. 725T, ST. LOUIS, MO, 63105, US

(73) Assignee: GENERAL ELECTRIC COMPANY, Schenectady, NY (US)

(21) Appl. No.: 11/944,603

(22) Filed: Nov. 23, 2007

(51) Int. Cl. G06Q 50/00

(52) U.S. Cl. 705/3

(57) ABSTRACT

Systems, methods and apparatus are provided through which in some embodiments a normal database of metadata information is created from a standardization/normalization transformation of individual data values pertaining to all the labels in all axes of normal data. In some additional embodiments, a statistical metric is established from which is determined individual label-based abnormalities. In some additional embodiments, deviation of patient metadata from normal is displayed in a visual manner that lends to a holistic view of the results.

### FIELD OF THE INVENTION

This invention relates generally to medical diagnosis, and more particularly to analysis of medical images of a patient.

### BACKGROUND OF THE INVENTION

Neurodegenerative disorders are both difficult to detect at an early stage and hard to quantify in a standardized manner for comparison across different patient populations. Investigators have developed methods to determine statistical deviations from normal patient populations using imaging. For example, in U.S. patent application Ser. No. 11/240,609, a database of images that includes categorized levels of severity of a disease or medical condition is generated from human designation of the severity. In some embodiments, the severity of a disease or medical condition is diagnosed by comparison of a patient image to images in the database. In some embodiments, changes in the severity of a disease or medical condition of a patient are measured by comparing a patient image to images in the database.

### BRIEF DESCRIPTION OF THE INVENTION

In one aspect, healthcare metadata information is analyzed for data values and visualized using normalization and standardization processes.

In another aspect, a normal reference for all metadata information is created, abnormality of a patient determined from the normal reference, and the patient abnormality is visualized in an intuitive and holistic manner.

In yet another aspect, a method to prepare data for visualization includes determining at least one deviation between the normalized subject statistics and patient metadata for each of a plurality of medical tests in which each of a plurality of clinical-test labels in the patient metadata is compared to a corresponding clinical-test label in the normalized subject statistics, and the method also includes generating Z-score synthetic images of the deviation.

In still another aspect, a system includes a processor, a storage device coupled to the processor, and software apparatus operative on the processor to access normalized and standardized metadata of a plurality of normal subjects acquired using a plurality of medical tests, determine statistics of the normalized and standardized metadata of normal subjects for each of the plurality of medical tests, access normalized and standardized metadata of a patient acquired using the plurality of medical tests, determine at least one deviation between the normal subjects statistics and the patient metadata for each of the plurality of medical tests, and display a visual representation of deviation for each of the plurality of medical tests.

Systems, clients, servers, methods, and computer-readable media of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 is a block diagram of an overview of a system to analyze normalized medical test metadata in comparison to clinical patient metadata, according to an embodiment;

FIG. 2 is a flowchart of a method to analyze normalized medical test metadata in comparison to clinical patient metadata, according to an embodiment;

FIG. 3 is a flowchart of a method to determine deviations, according to an embodiment;

FIG. 4 is a flowchart of a method to determine deviations, according to an embodiment;

FIG. 5 is a flowchart of a method to determine deviations, according to an embodiment;

FIG. 6 is a flowchart of a method to prepare normal subject metadata for analysis, according to an embodiment;

FIG. 7 is a flowchart of a method to visualize patient metadata deviations, according to an embodiment;

FIG. 8 is a flowchart of a method to visualize patient metadata deviations, according to an embodiment;

FIG. 9 is a listing of tables of normal metadata, according to an embodiment;

FIG. 10 is a table of normal metadata, according to an embodiment;

FIG. 11 is an example of a patient Z-score synthetic image, according to an embodiment;

FIG. 12 is a simplified diagram of an overview of a modified system configured to improve X-ray imaging operations; and

FIG. 13 is a block diagram of a hardware and operating environment useful in the context of the environment of FIG. 12, according to an embodiment

### DETAILED DESCRIPTION OF THE INVENTION

In the following detailed description, reference is made to the accompanying drawings that form a part hereof, and in which is shown by way of illustration specific embodiments which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

The detailed description is divided into five sections. In the first section, a system level overview is described. In the second section, embodiments of methods are described. In the third section, particular implementations are described. In the fourth section hardware and operating environment in conjunction with which embodiments can be practiced are described. Finally, in the fifth section, a conclusion of the detailed description is provided.

### System Level Overview

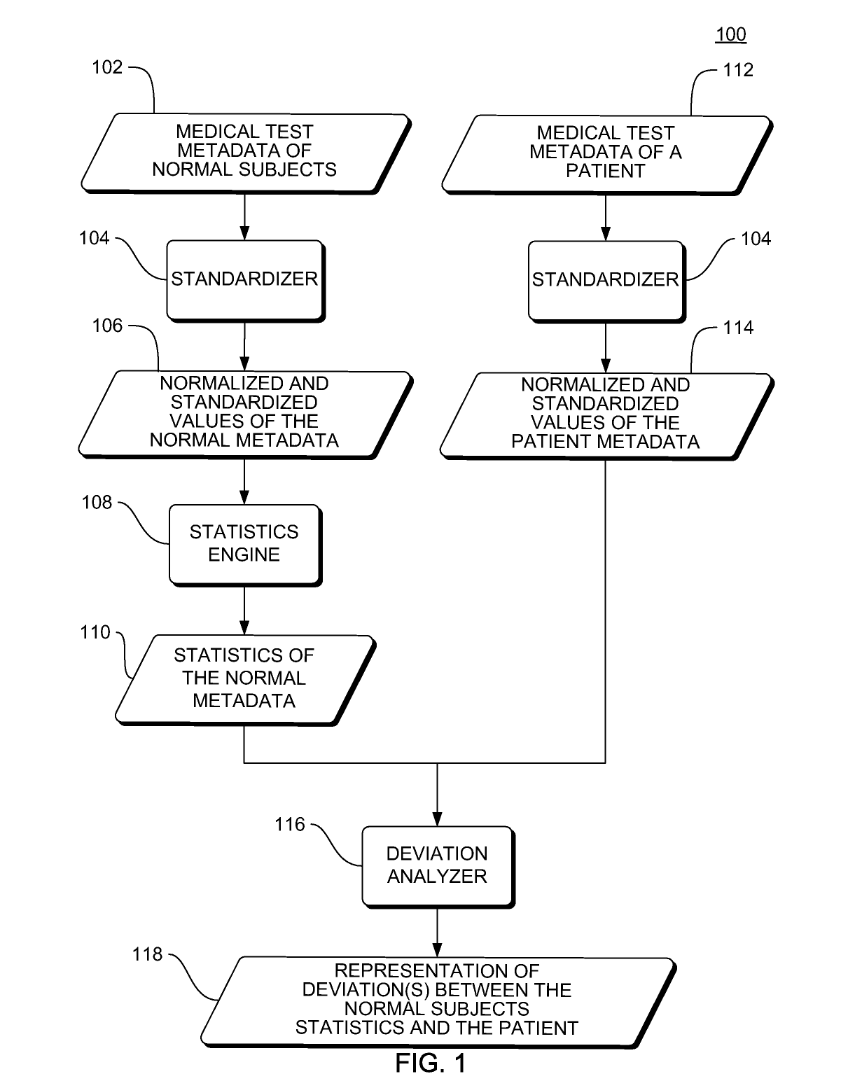

FIG. 1 is a block diagram of an overview of a system 100 to analyze normalized medical test metadata in comparison to clinical patient metadata, according to an embodiment. System 100 gathers diagnostic metadata information and creates descriptors that define normal state which can be used to identify abnormal states in a patient.

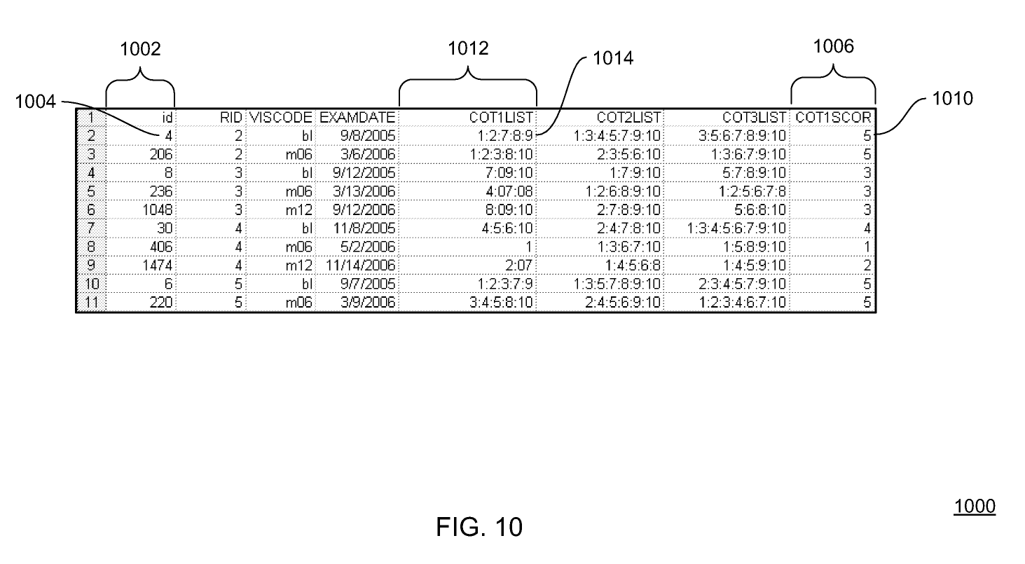

System 100 includes medical test metadata 102, or other healthcare test metadata of normal subjects. The normal medical test metadata 102 is acquired from one or more medical tests of a number of people. For example, in some embodiments the metadata describes weight, height, pulse, temperature, blood pressure systole and diastole data, heart rate data, blood serum data, and/or CSF spinal fluid data of the normal test subjects. Each of these labels have data values associated with them e.g. blood pressure of 110/80 (systole/diastole). The normal medical test metadata 102 is described in greater detail in FIG. 10 below.

The medical test metadata 102 of normal subjects is received by a standardizer 104 that normalizes and/or standardizes the medical test metadata 102, thus generating normalized and/or standardized medical metadata 106 of a plurality of normal subjects. System 100 also includes a statistics engine 108 that determines statistics 110 of the normalized and standardized metadata 106 of the normal subjects. The statistics engine 108 operates on the normalized and/or standardized metadata 106 of the each of the medical test(s).

System 100 includes medical test metadata 112, or other healthcare test metadata of a patient. In some embodiments, the patient medical test metadata 112 is acquired from the medical test(s).

The patient medical test metadata 112 is received by a standardizer 104 that normalizes and/or standardizes the patient medical test metadata 112, thus generating normalized and/or standardized patient medical metadata 114.

System 100 also includes a deviation analyzer 116 that determines deviation(s) 118 between the normal subject's statistic(s) 110 and the patient metadata 114 for each of the medical test(s).

Some embodiments of system 100 not shown also include a component to generate a visual graphical representation of the deviation(s) 118 for each of the patient medical test(s). Thus system 100 helps identify and determine disease severity in the patient when compared against a cohort of normal controls using a structured approach based on a comprehensive data.

While the system 100 is not limited to any particular normal medical test metadata 102, standardizer 104, normalized and standardized metadata 106, statistics engine 108, statistics 110, patient medical test metadata 112, normalized and standardized metadata 114 of a patient, deviation analyzer 116, deviation(s) 118 between the normal subject's statistic(s) and the patient metadata, for sake of clarity, normal medical test metadata 102, standardizer 104, simplified normalized and standardized metadata 106, statistics engine 108, statistics 110, patient medical test metadata 112, normalized and standardized metadata 114 of a patient, deviation analyzer 116, deviation(s) 118 between the normal subject's statistic(s) and the patient metadata are described.

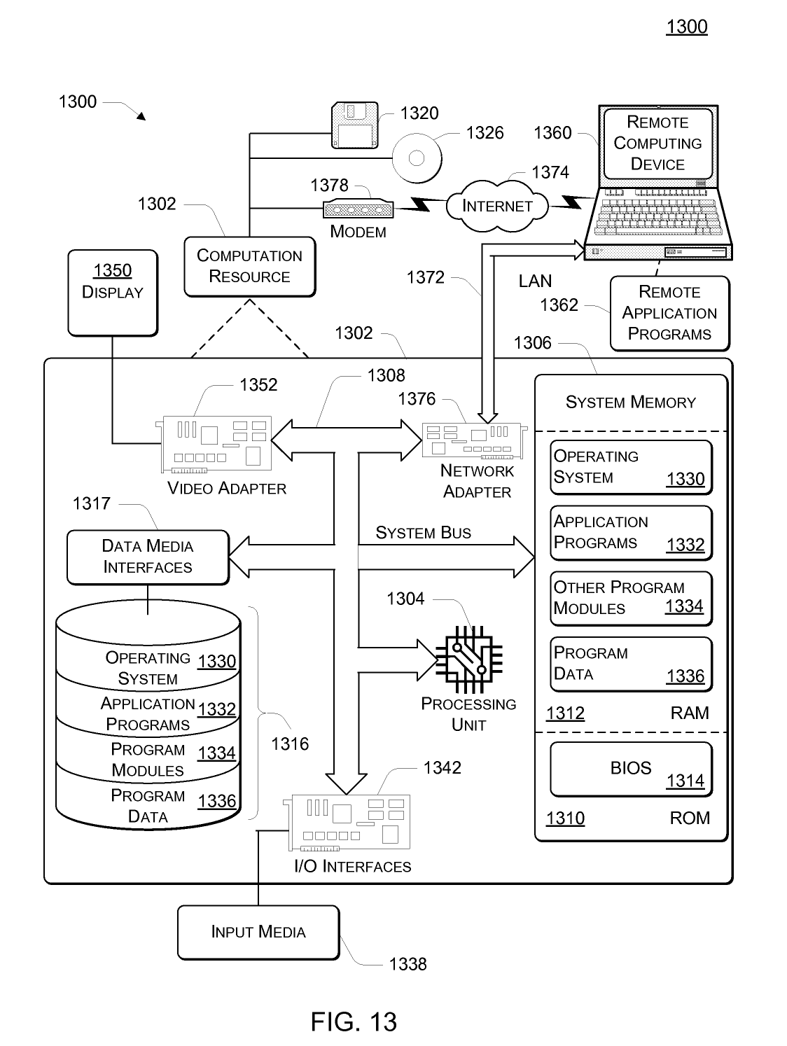

The system level overview of the operation of an embodiment is described above in this section of the detailed description. Some embodiments operate in a multi-processing, multi-threaded operating environment on a computer, such as general computer environment 1300 in FIG. 13.

### Method Embodiments

In the previous section, a system level overview of the operation of an embodiment is described. In this section, the particular methods of such an embodiment are described by reference to a series of flowcharts. Describing the methods by reference to a flowchart enables one skilled in the art to develop such programs, firmware, or hardware, including such instructions to carry out the methods on suitable computers, executing the instructions from computer-readable media. Similarly, the methods performed by the server computer programs, firmware, or hardware are also composed of computer-executable instructions. Methods 200-800 are performed by a program executing on, or performed by firmware or hardware that is a part of, a computer, such as general computer environment 1300 in FIG. 13

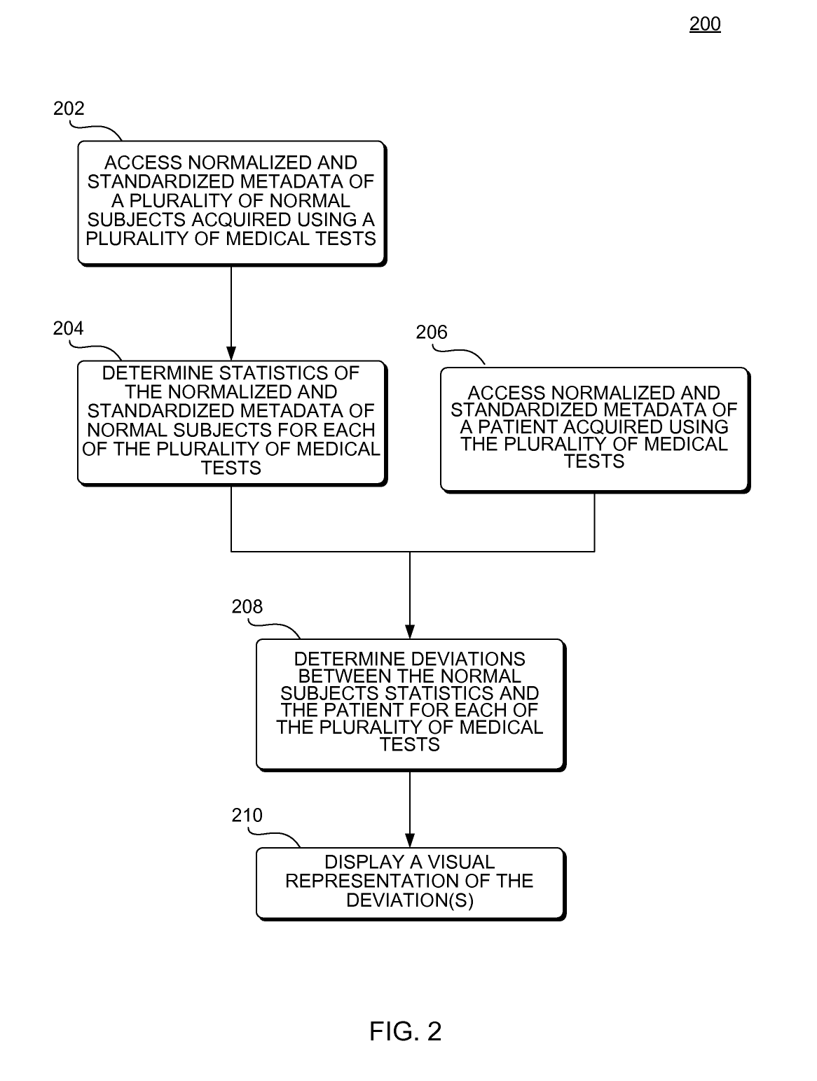

FIG. 2 is a flowchart of a method 200 to analyze normalized medical test metadata in comparison to clinical patient metadata, according to an embodiment. System 200 gathers diagnostic metadata information and creates descriptors that define normal state which can be used to identify abnormal states in a patient.

Method 200 includes accessing normalized and standardized metadata of a plurality of normal subjects, at block 202. The metadata is acquired from one or more medical tests. The metadata is described in greater detail in FIG. 10 below.

Method 200 also includes determining statistics of the normalized and standardized metadata of normal subjects, for each of the medical test(s), at block 204.

Method 200 also includes accessing normalized and standardized metadata of a patient acquired using the medical test(s), at block 206.

Method 200 also includes determining deviation(s) between the normal subjects' statistics and the patient metadata for each of the medical test(s), at block 208. In some embodiments, the deviation of each patient's metadata from the normal database's mean value is determined according to the following equation:

$$Δ {a}_{i} = \frac{{a}_{i} - {μ}_{{a}_{i}}}{{σ}_{{a}_{i}}} \qquad Equation 1$$

In Equation 1, αᵢ is the i^{th} label of axis “a” and σ_{α}_{ᵢ} and μ_{α}_{ᵢ}. Equation 1 is applied to all the labels in all the axes and the resultant is a deviation metadata “vector”. Equation 1 is also known as the Z-score, standard score or normal score.

Method 200 also includes displaying a visual representation of deviation for each of the medical test(s), at block 210. Display 210 of the metadata provides disease evaluation in a holistic and visual form. This invention describes a method of displaying the deviation metadata in a consistent and visually acceptable sense that may allow for a better disease detection as the information is presented to the visual cortex of the brain for pattern matching rather than the memory recall that is the current practice.

One illustrative example is that all the metadata is ordered in a consistent from (ordering using clinical relevance is best) where the rows represent the axes and the columns represent each label within that axis. Each active pixel of this graph is assigned a color from a color scale that maps the deviation value of the label to a conspicuous concern value. The practitioner can see the pattern of deviation along with their relative degree of concern in one snapshot for a whole host of axis. This will allow for a rapid and consistent diagnosis.

Thus, method 200 provides a standardized technique of visually exploring patient metadata information when compared to normal data for specific health condition(s).

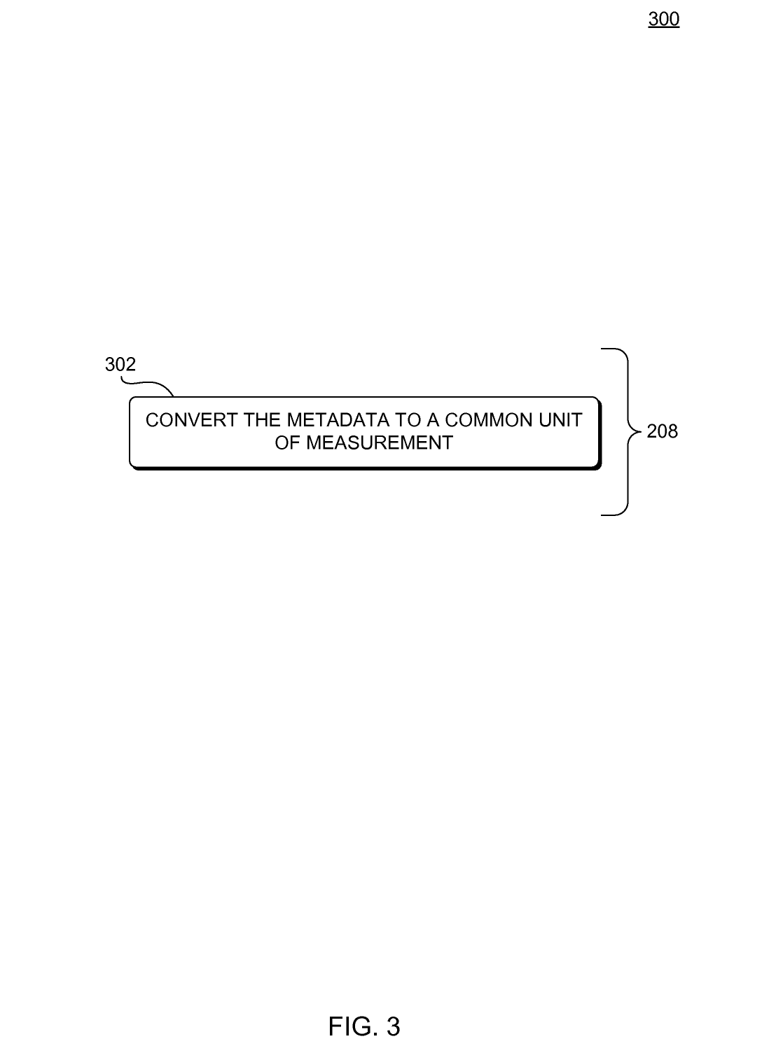

FIG. 3 is a flowchart of a method 300 to determine deviations, according to an embodiment. Method 300 is performed by the standardizer 104 in FIG. 1.

Method 300 includes converting the metadata to a common unit of measurement, at block 302. In situations where the metadata is represented in various units of measurement, determining a deviation includes changing the metadata to one particular unit of measurement in order to avoid a mathematically invalid deviation.

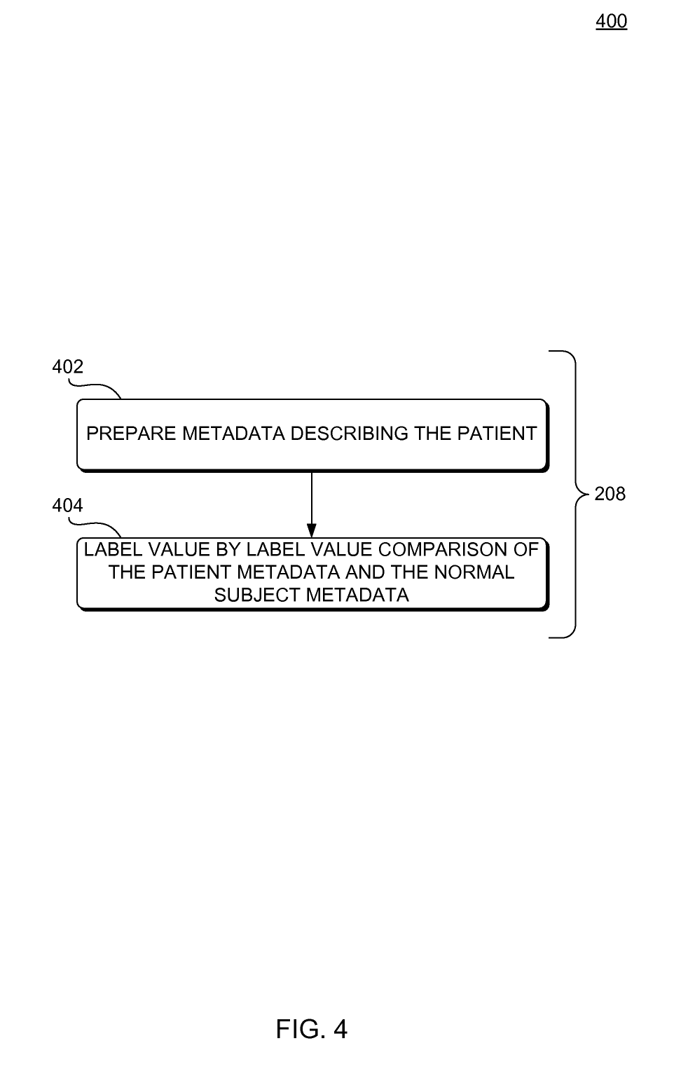

FIG. 4 is a flowchart of a method 400 to determine deviations, according to an embodiment. Method 400 is one example of determining deviation(s) 208 in FIG. 2.

Method 400 includes preparing metadata describing the patient, at block 402.

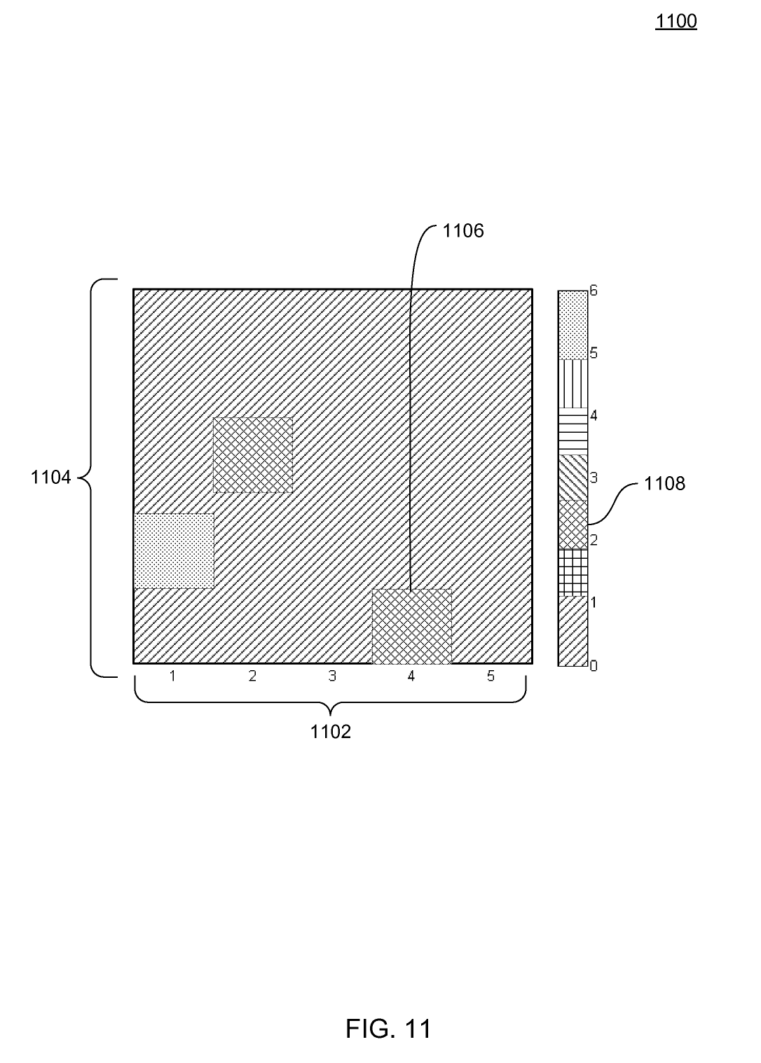

Method 400 includes label value-by-label value comparison of each clinical-test label in the patient metadata to a corresponding clinical-test label in the comparison of the patient metadata and the normal subject metadata, at block 404. See FIG. 11 for detailed information in the labels. Each clinical-test label belongs to a clinical category in the patient metadata.

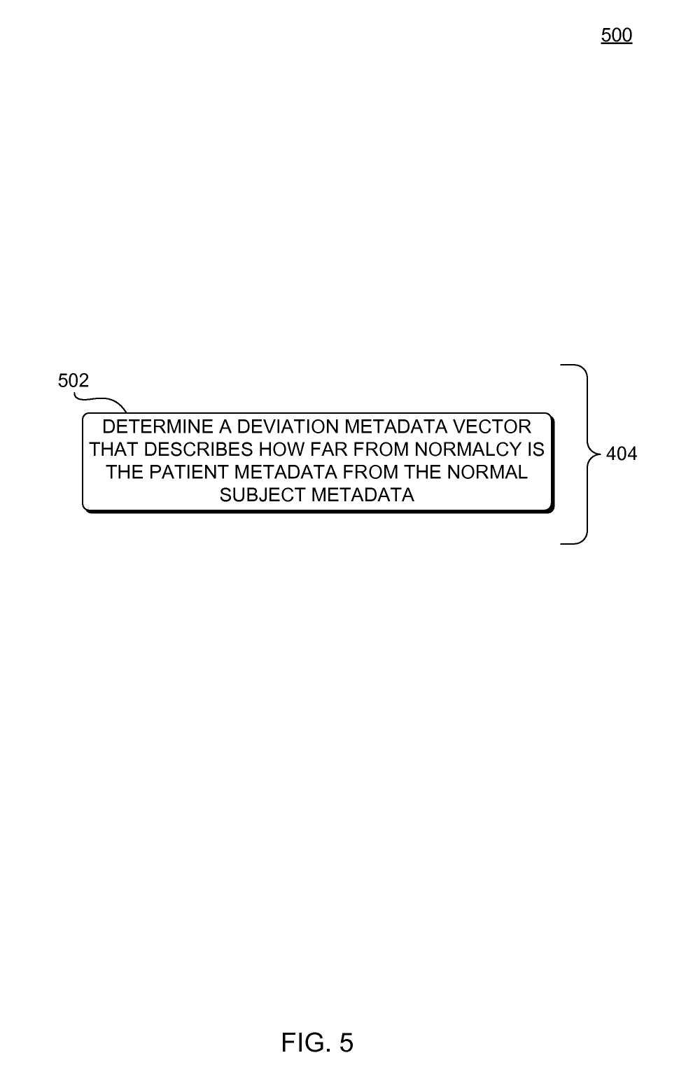

FIG. 5 is a flowchart of a method 500 to determine deviations, according to an embodiment. Method 500 is one example of determining deviation(s) 208 in FIG. 2.

Method 500 includes determining a deviation metadata vector that describes how far from normalcy is the patient metadata from the normal subject metadata, at block 502.

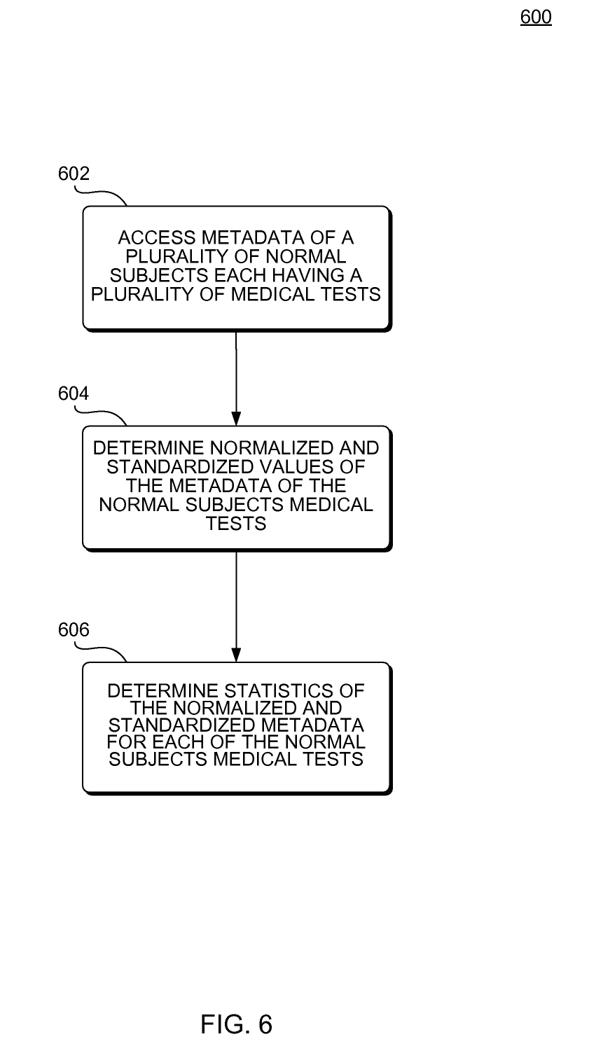

FIG. 6 is a flowchart of a method 600 to prepare normal subject metadata for analysis, according to an embodiment. Method 600 includes accessing metadata of a plurality of normal subjects acquired using a plurality of medical tests, at block 602. Method 600 also includes determining normalized and standardized values of the metadata of the plurality of normal subjects acquired using the plurality of medical tests, at block 604.

Method 600 also includes determining statistics of the normalized and standardized metadata of normal subjects for each of the plurality of medical tests, at block 606.

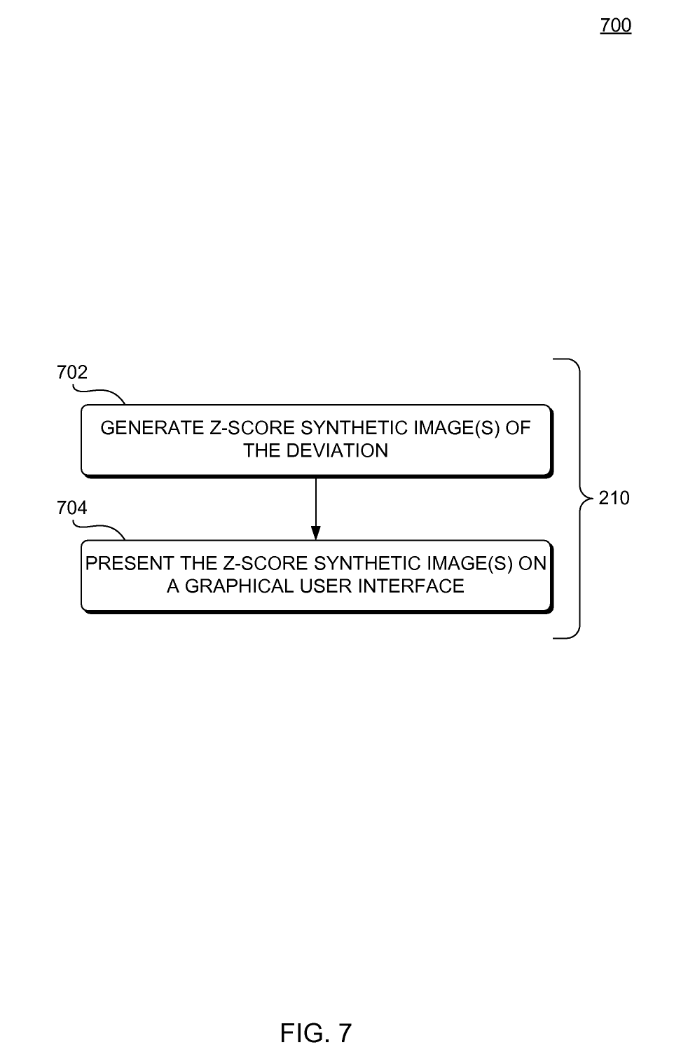

FIG. 7 is a flowchart of a method 700 to visualize patient metadata deviations, according to an embodiment.

Method 700 includes generating Z-score synthetic images of the deviation metadata describing the patient, at block 702. The Z-score synthetic image is not an organ image. Each Z-score synthetic image includes a graphic representation of a Z-score image, in table image format representation that displays the deviation from the norm and Z-scores. Each of a plurality of labels is represented by a particular pixel in the image. In one particular example, 10,000 labels is represented in a Z-score synthetic image a 100×100 image, which provides a snap-shot of all deviation data for quick review to identify abnormal conditions.

Method 700 also includes presenting the Z-score synthetic image on a graphical user interface, at block 704.

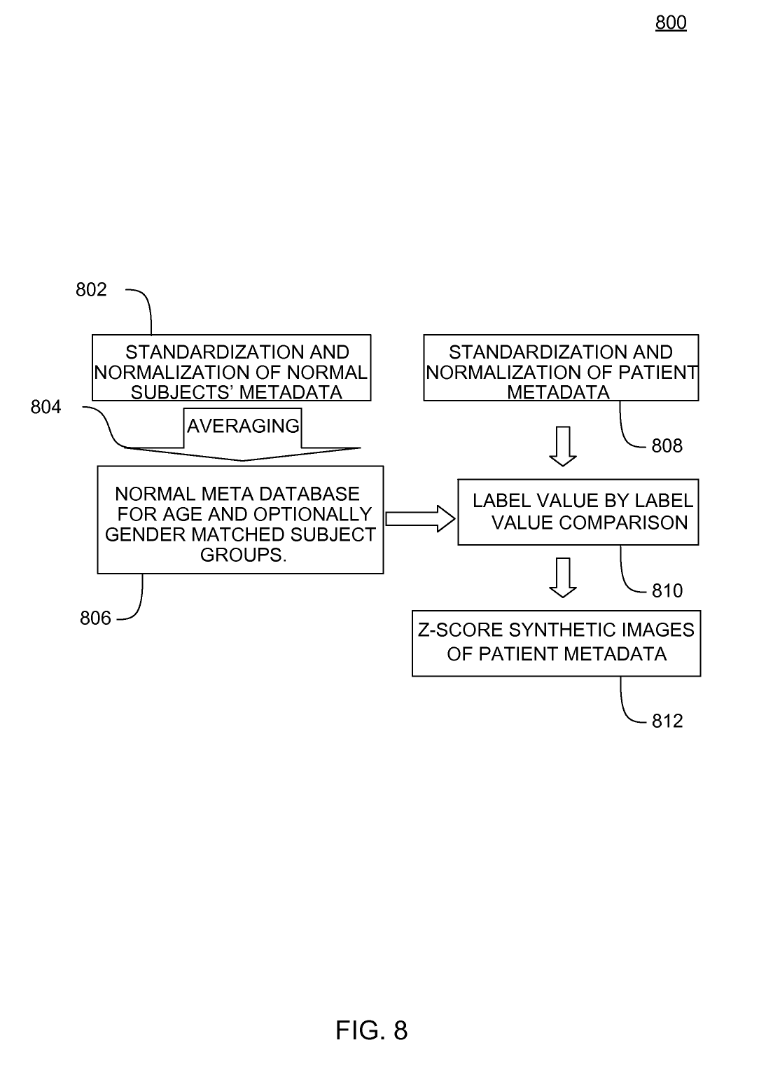

FIG. 8 is a flowchart of a method 800 to visualize patient metadata deviations, according to an embodiment.

Method 800 includes standardizing and normalizing metadata of a number of subjects, at block 802. Then, an average of the data is determined, at block 804. Thereafter, database of normal metadata, for age and optionally gender matched subject groups, is created, at block 806. The database can be anatomy specific and contain mean and standard deviation metadata of normal subject metadata sets. A well-defined normal cohort is used to create the database of normal metadata. The set of normal cohort are clinically tested to determine the normal metadata information. In the standardized space each label is assigned a mean value and associated standard deviation based on the data samples from the cohort of normal cases. In addition, method 800 includes standardizing and normalizing metadata of a patient, at block 808.

Thereafter, a comparison of each of number of labels in the normalized subject database and the patient database is performed, at block 810. A Z-score synthetic image of the comparison is generated, at block 812.

Method 800 provides creation of a normal database of metadata information using a standardization/normalization transformation of individual data values pertaining to all the labels in all the axes. In addition a statistical metric is established that is used to determine individual label based abnormalities. And finally the deviation from normal is displayed in a visual manner that lends to a holistic view of the results.

In some embodiments, methods 200-800 are implemented as a computer data signal embodied in a carrier wave, that represents a sequence of instructions which, when executed by a processor, such as processing unit 1304 in FIG. 13, cause the processor to perform the respective method. In other embodiments, methods 200-800 are implemented as a computer-accessible medium having executable instructions capable of directing a processor, such as processing unit 1304 in FIG. 13, to perform the respective method. In varying embodiments, the medium is a magnetic medium, an electronic medium, or an optical medium.

### Apparatus

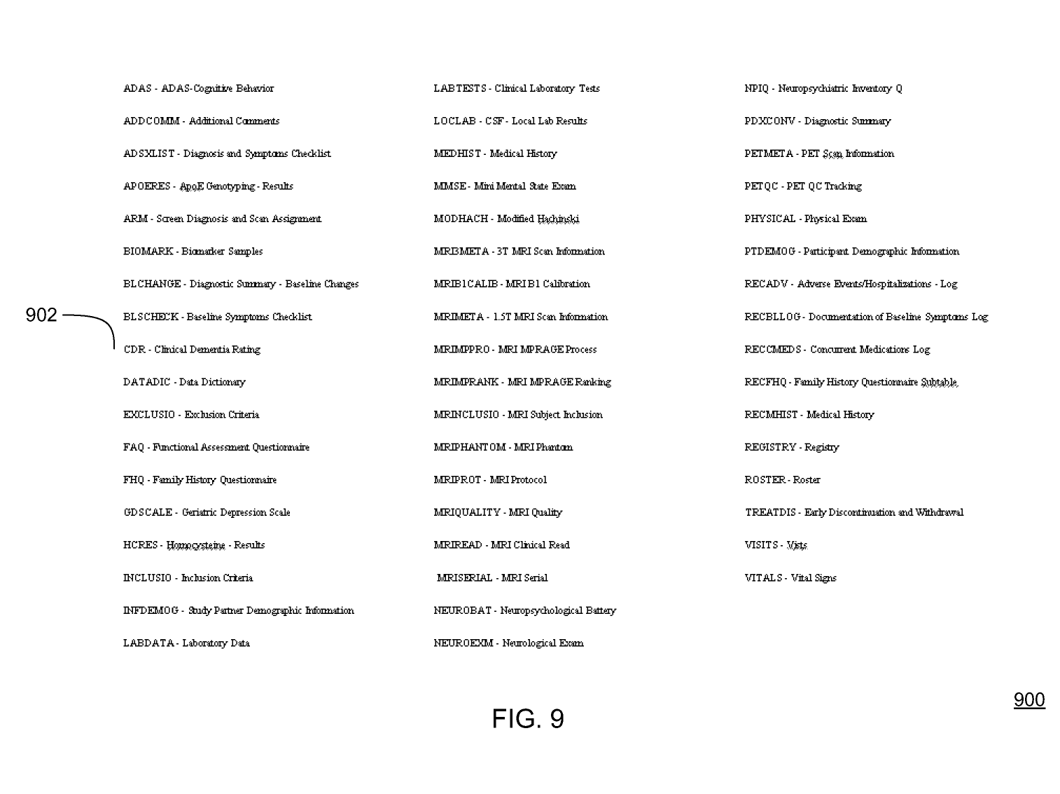

Referring to FIGS. 9-11, a particular implementation is described in conjunction with the system overview in FIG. 1 and the methods described in conjunction with FIGS. 2-8.

FIG. 9 is a listing 900 of tables of metadata, according to an embodiment. The listing 900 is a listing provided by the Alzheimer's Disease Neuroimaging Initiative (ADNI) that is operated by the Laboratory of Neuro Imaging, Department of Neurology, UCLA School of Medicine, 635 Charles Young Drive South, Suite 225, Los Angeles, Calif. 90095-7334. Listing 900 is merely one example of a listing of tables of metadata. Other listings for other diseases are available and even more listings are possible for Alzheimer's disease and other diseases. The systems, methods and apparatus described herein are not restricted to Alzheimer disease of metadata.

Each of the tables, such as CDR—clinical dementia rating 902, provides data describing or representing clinical tests and information that is gathered of a number of patients for the purpose of a diagnosis. One example of a table is shown below in FIG. 10.

FIG. 10 is a table 1000 of normal metadata, according to an embodiment. Table 1000 is one example of a table 1000 of normal metadata that is stored in a spreadsheet data format and displayed by a spreadsheet program. In table 1000, each label is a column in the table of the normal metadata. For example, one label is column “id” 1002 that includes a number of patient identification numbers, such as patent ID “4” 1004. However, the label “id” 1002 is not normal data that is analyzed to determine normal data.

Nonetheless, one example of data that is analyzed to determine normal data is label “COTISCOR” 1006. Label “COTISCOR” 1006 includes data for patient ID “4” that indicates a value 1008 of “5.” In one example of using label “COTISCOR” 1006 to determine normal data, some and/or all of the values in label “COTISCOR” 1006 can be input as normalized and standardized medical test metadata of normal subjects 106 to the statistics engine 108 in FIG. 1, and to the extent that Equation 1 above is performed on the data values of label “COTISCOR” 1006. In other examples, the values in label “COTISCOR” 1006 and the values of other labels in table 1000 and/or the value of other labels in at least one other table (not shown) can be input as normalized and standardized medical test metadata of normal subjects 106 to the statistics engine 108 in FIG. 1, and to the extent that Equation 1 above is performed on the data values of label “COTISCOR” 1006 and the data values of the other labels.

In some embodiments of table 1000, each label further comprises sub-label(s) that are separated by delimiters, such as shown in label “COTILIST” 1012. For example, label “COTILIST” 1012 includes sublabels 1, 2, 7, 8 and 9 that are separated by the delimiter “:” semicolon.

Columns in the normal metadata table correspond to columns in patient metadata. In some embodiments, the correspondence of the label of the normal metadata and the patient metadata is determined by identifying a corresponding (e.g. identical) column name.

FIG. 11 is an example of a patient Z-score synthetic image 1100, according to an embodiment. Each clinical-test label belongs to a clinical category in the patient metadata.

Each row is a clinical category 1104 and each column 1102 is a clinical test for the clinical category. In the example of patient Z-score synthetic image 1100, a number of clinical tests 1102 are plotted in reference to a severity index 1108. For example, clinical test 1106 is shown as having a severity of “2” 1108. In other embodiments, the various severity levels are color-coded as displayed on a graphical user interface (GUI).

Apparatus components can be embodied as computer hardware circuitry or as a computer-readable program, or a combination of both. More specifically, in the computer-readable program embodiment, the programs can be structured in an object-orientation using an object-oriented language such as Java, Smalltalk or C++, and the programs can be structured in a procedural-orientation using a procedural language such as COBOL or C. The software components communicate in any of a number of means that are well-known to those skilled in the art, such as application program interfaces (API) or interprocess communication techniques such as remote procedure call (RPC), common object request broker architecture (CORBA), Component Object Model (COM), Distributed Component Object Model (DCOM), Distributed System Object Model (DSOM) and Remote Method Invocation (RMI). The components execute on as few as one computer as in general computer environment 1300 in FIG. 13, or on at least as many computers as there are components.

### Hardware and Operating Environment

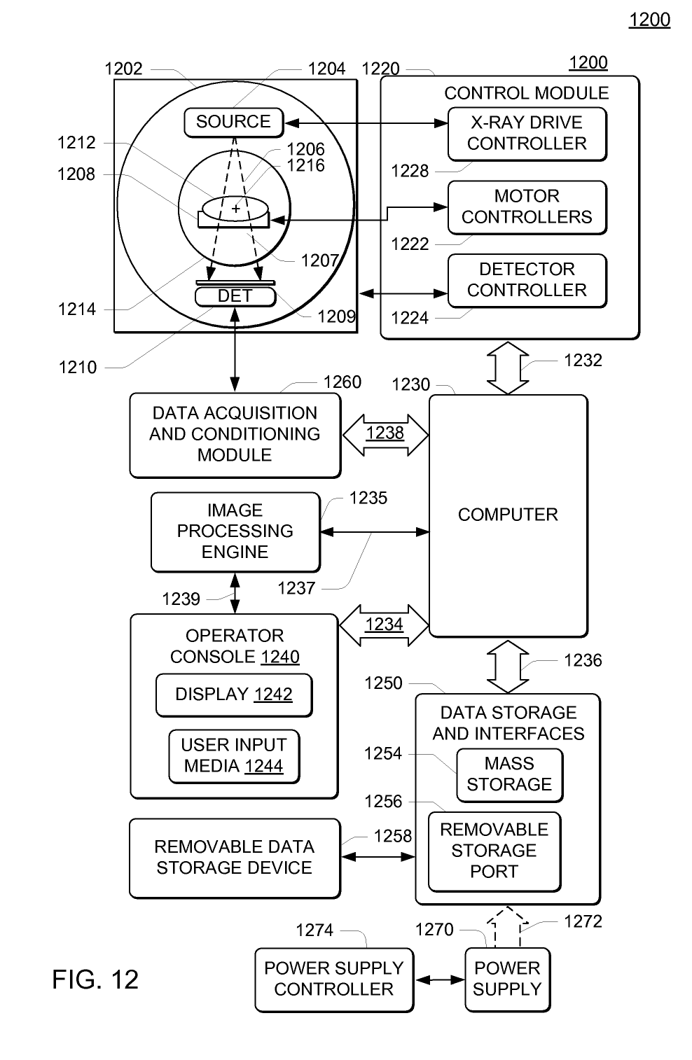

FIG. 12 is a simplified diagram of an overview of a modified system 1200 configured to improve X-ray imaging operations. The system 1200 optionally includes a gantry 1202 or other support for an illumination source 1204, such as an X-ray illumination source, capable of providing illumination 1206, such as X-rays or other non-destructive internal imaging illumination, and can optionally include a test subject support 1208 that is transmissive with respect to the illumination 1206 and that is positioned above a scintillator 1209 and detector 1210 that is also opposed to the illumination source 1204. Alternatively, a direct conversion detector 1210 can be employed without need for a scintillator.

In one embodiment, components of the system 1200 and a test subject 1212 are maintained in a defined geometric relationship to one another by the gantry 1202. A distance between the illumination source 1204 and the detector 1210 can be varied, depending on the type of examination sought, and the angle of the illumination 1206 respective to the test subject 1212 can be adjusted with respect to the body to be imaged responsive to the nature of imaging desired.

In one embodiment, the test subject support 1208 is configured to support and/or cause controlled motion of the test subject 1212, such as a living human or animal patient, or other test subject 1212 suitable for non-destructive imaging, above the scintillator 1209/detector 1210 so that illumination 1207 is incident thereon after passing through the test subject 1212. In turn, information from the detector array 1210 describes internal aspects of the test subject 1212.

The scintillator 1209 can be a conventional CsI scintillator 1209, optically coupled to an array of photodiodes (not illustrated), such as a two-dimensional array of photodiodes and suitable control transistors formed using semiconductor material such as amorphous silicon, or any other form of detector 1210 suitable for use with the type or types of illumination 1206 being employed, such as X-rays. The detector elements are typically tessellated in a mosaic. The scintillator 1209 converts incident photons comprising electromagnetic radiation, such as X-rays, from high-energy, high-frequency photons 1207, into lower-energy, lower-frequency photons corresponding to spectral sensitivity of the detector elements, in a fashion somewhat analogous to fluorescence, as is commonly known in the context of many visible-light sources in use today. Alternatively, the detector 1210 can be formed as a flat-panel array including amorphous Silicon (α-Si) active elements, together with either a scintillator layer 1209, or a direct converter material such as Cadmium Zinc Telluride (CdZnTe), Mercuric Iodide (Hgl₂), Lead Iodide (Pbl₂), or amorphous Selenium (α-Se).

In some modes of operation, such as CT, the gantry 1202 and test subject support or table 1208 cooperatively engage to move the test subject 1212 longitudinally within an opening 1214, that is, along an axis 1216 extending into and out of the plane of FIG. 12. In some modes of operation, the gantry 1202 rotates the X-ray source 1204 and detector 1210 about the axis 1216, while the support 1208 moves longitudinally, to provide a helical series of scans of the test subject 1212, where a pitch of the helices is defined as a ratio of a longitudinal distance traveled by the table 1208 during a complete revolution of the gantry 1202, compared to a length of the detector 1210 along the axis 1216 of linear motion.

The system 1200 also optionally includes a control module or controller 1220. The controller 1220 can include a motor control module 1222 configured to move the test subject support 1208 and thus the test subject 1212 relative to the X-ray source 1204 and/or detector 1210, and can also control motors in the gantry 1202 or to position the X-ray illumination source 1204 relative to the test subject 1212 and/or the detector 1210.

The controller 1220 includes a detector controller 1224 configured to control elements within the detector 1210 and to facilitate data transfer therefrom. The controller 1220 also includes a drive parameter controller 1228 configured to control electrical drive parameters delivered to the X-ray source 1204. One or more computers 1230 provide connections to the controller 1220 via a bus 1232 configured for receiving data descriptive of operating conditions and configurations and for supplying appropriate control signals. Buses 1234, 1237 and 1239 act to transfer data and control signals, for example with respect to a module 1235, configured as an image processing engine, via interconnections such as 1237, 1239 that are configured for exchange of signals and data to and/or from the computer 1230 as well as other elements of the system 1200 and/or external computation or communications resources (not illustrated in FIG. 12).

The system 1200 also includes a bus 1236, a bus 1238 and an operator console 1240. The operator console 1240 is coupled to the system 1200 through the bus 1234. The operator console 1240 includes one or more displays 1242 and a user input interface 1244. The user input interface 1244 can include a touchscreen, keyboard, a mouse or other tactile input device, capability for voice commands and/or other input devices. The one or more displays 1242 provide video, symbolic and/or audio information relative to operation of system 1200, user-selectable options and images descriptive of the test subject 1212, and can display a graphical user interface for facilitating user selection among various modes of operation and other system settings.

The image processing engine 1235 facilitates automation of accurate measurement and assessment. The image processing engine 1235 is capable of forming multiple, coordinated images for display, for example via the monitor 1242, to provide the types of depictions described below. The image processing engine 1235 can comprise a separate and distinct module, which can include application-specific integrated circuitry, or can comprise one or more processors coupled with suitable computer-readable program modules, or can comprise a portion of the computer 1230 or other computation device.

The system 1200 also includes memory devices 1250, coupled via the bus 1236 to the computer 1230 through suitable interfaces. Datasets representing three-dimensional data and image or two-dimensional data typically conform to the digital imaging and communications in medicine (DICOM) standard, which is widely adopted for handling, storing, printing, and transmitting information in medical imaging. The DICOM standard includes a file format definition and a network communications protocol. The communication protocol is an application protocol that uses TCP/IP to communicate between systems. DICOM files can be stored in memory devices 1250 and retrieved therefrom, and can be exchanged between two entities that are capable of receiving image and patient data in DICOM format.

The memory devices 1250 include mass data storage capabilities 1254 and one or more removable data storage device ports 1256. The one or more removable data storage device ports 1256 are adapted to detachably couple to portable data memories 1258, which can include optical, magnetic and/or semiconductor memories and can have read and/or write capabilities, and which can be volatile or non-volatile devices or can include a combination of the preceding capabilities.

The system 1200 further includes a data acquisition and conditioning module 1260 that has data inputs coupled to the detector 1210 and that is coupled by the bus 1238 to the one or more computers 1230. The data acquisition and conditioning module 1260 includes analog to digital conversion circuitry for capturing analog data from the detector 1210 and then converting those data from the detector 1210 into digital form, to be supplied to the one or more computers 1230 for ultimate display via one or more of the displays 1242 and for potential storage in the mass storage device 1254 and/or data exchange with remote facilities (not shown in FIG. 12). The acquired image data can be conditioned in either the data acquisition and conditioning module 1260 or the one or more computers 1230 or both.

The system 1200 also includes a power supply 1270, coupled via interconnections represented as a power supply bus 1272, shown in dashed outline, to other system elements, and a power supply controller 1274. In some embodiments, the system 1200 is configured to be a mobile system equipped with a portable power supply 1270, such as a battery. In other words, the system 1200 can comprise a wheeled unit and can be electromotively powered in self-contained fashion, lending physical agility to the ensemble of attributes offered by the system 1200.

Volumetric data collected via exposure of the test subject 1212 to suitable illumination 1206 can be processed via many different types of tools, each intended to enhance some portion of information content described by the data. One result can be inconsistency between analytical results from different types of signal processing tools, or between measurement results corresponding to different measurement times and/or measurement phases.

FIG. 13 is a block diagram of a hardware and operating environment 1300 useful in the context of the environment of FIG. 12, in accordance with an embodiment of the disclosed subject matter.

The description of FIG. 13 provides an overview of computer hardware and a suitable computing environment in conjunction with which some embodiments can be implemented. Embodiments are described in terms of a computer executing computer-executable instructions. However, some embodiments can be implemented entirely in computer hardware in which the computer-executable instructions are implemented in read-only memory. Some embodiments can also be implemented in client/server computing environments where remote devices that perform tasks are linked through a communications network. Program modules can be located in both local and remote memory storage devices in a distributed computing environment.

The general computer environment 1300 includes a computation resource 1302 capable of implementing the processes described herein. It will be appreciated that other devices can alternatively used that include more components, or fewer components, than those illustrated in FIG. 13.

The illustrated operating environment 1300 is only one example of a suitable operating environment, and the example described with reference to FIG. 13 is not intended to suggest any limitation as to the scope of use or functionality of the embodiments of this disclosure. Other well-known computing systems, environments, and/or configurations can be suitable for implementation and/or application of the subject matter disclosed herein.

The computation resource 1302 includes one or more processors or processing units 1304, a system memory 1306, and a bus 1308 that couples various system components including the system memory 1306 to processor(s) 1304 and other elements in the environment 1300. The bus 1308 represents one or more of any of several types of bus structures, including a memory bus or memory controller, a peripheral bus, an accelerated graphics port and a processor or local bus using any of a variety of bus architectures, and can be compatible with SCSI (small computer system interconnect), or other conventional bus architectures and protocols.

The system memory 1306 includes nonvolatile read-only memory (ROM) 1310 and random access memory (RAM) 1312, which can or can not include volatile memory elements. A basic input/output system (BIOS) 1314, containing the elementary routines that help to transfer information between elements within computation resource 1302 and with external items, typically invoked into operating memory during start-up, is stored in ROM 1310.

The computation resource 1302 further can include a non-volatile read/write memory 1316, represented in FIG. 13 as a hard disk drive, coupled to bus 1308 via a data media interface 1317 (e.g., a SCSI, ATA, or other type of interface); a magnetic disk drive (not shown) for reading from, and/or writing to, a removable magnetic disk 1320 and an optical disk drive (not shown) for reading from, and/or writing to, a removable optical disk 1326 such as a CD, DVD, or other optical media.

The non-volatile read/write memory 1316 and associated computer-readable media provide nonvolatile storage of computer-readable instructions, data structures, program modules and other data for the computation resource 1302. Although the exemplary environment 1300 is described herein as employing a non-volatile read/write memory 1316, a removable magnetic disk 1320 and a removable optical disk 1326, it will be appreciated by those skilled in the art that other types of computer-readable media which can store data that is accessible by a computer, such as magnetic cassettes, FLASH memory cards, random access memories (RAMs), read only memories (ROM), and the like, can also be used in the exemplary operating environment.

A number of program modules can be stored via the non-volatile read/write memory 1316, magnetic disk 1320, optical disk 1326, ROM 1310, or RAM 1312, including an operating system 1330, one or more application programs 1332, other program modules 1334 and program data 1336. Examples of computer operating systems conventionally employed for some types of three-dimensional and/or two-dimensional medical image data include the NUCLEUS® operating system, the LINUX® operating system, and others, for example, providing capability for supporting application programs 1332 using, for example, code modules written in the C++® computer programming language.

A user can enter commands and information into computation resource 1302 through input devices such as input media 1338 (e.g., keyboard/keypad, tactile input or pointing device, mouse, foot-operated switching apparatus, joystick, touchscreen or touchpad, microphone, antenna etc.). Such input devices 1338 are coupled to the processing unit 1304 through a conventional input/output interface 1342 that is, in turn, coupled to the system bus. A monitor 1350 or other type of display device is also coupled to the system bus 1308 via an interface, such as a video adapter 1352.

The computation resource 1302 can include capability for operating in a networked environment (as illustrated in FIG. 12, for example) using logical connections to one or more remote computers, such as a remote computer 1360. The remote computer 1360 can be a personal computer, a server, a router, a network PC, a peer device or other common network node, and typically includes many or all of the elements described above relative to the computation resource 1302. In a networked environment, program modules depicted relative to the computation resource 1302, or portions thereof, can be stored in a remote memory storage device such as can be associated with the remote computer 1360. By way of example, remote application programs 1362 reside on a memory device of the remote computer 1360. The logical connections represented in FIG. 13 can include interface capabilities, e.g., such as interface capabilities 1252 (FIG. 12) a storage area network (SAN, not illustrated in FIG. 13), local area network (LAN) 1372 and/or a wide area network (WAN) 1374, but can also include other networks.

Such networking environments are commonplace in modern computer systems, and in association with intranets and the Internet. In certain embodiments, the computation resource 1302 executes an Internet Web browser program (which can optionally be integrated into the operating system 1330), such as the “Internet Explorer®” Web browser manufactured and distributed by the Microsoft Corporation of Redmond, Wash.

When used in a LAN-coupled environment, the computation resource 1302 communicates with or through the local area network 1372 via a network interface or adapter 1376. When used in a WAN-coupled environment, the computation resource 1302 typically includes interfaces, such as a modem 1378, or other apparatus, for establishing communications with or through the WAN 1374, such as the Internet. The modem 1378, which can be internal or external, is coupled to the system bus 1308 via a serial port interface.

In a networked environment, program modules depicted relative to the computation resource 1302, or portions thereof, can be stored in remote memory apparatus. It will be appreciated that the network connections shown are exemplary, and other means of establishing a communications link between various computer systems and elements can be used.

A user of a computer can operate in a networked environment 1200 using logical connections to one or more remote computers, such as a remote computer 1360, which can be a personal computer, a server, a router, a network PC, a peer device or other common network node. Typically, a remote computer 1360 includes many or all of the elements described above relative to the computer 1300 of FIG. 13.

The computation resource 1302 typically includes at least some form of computer-readable media. Computer-readable media can be any available media that can be accessed by the computation resource 1302. By way of example, and not limitation, computer-readable media can comprise computer storage media and communication media.

Computer storage media include volatile and nonvolatile, removable and non-removable media, implemented in any method or technology for storage of information, such as computer-readable instructions, data structures, program modules or other data. The term “computer storage media” includes, but is not limited to, RAM, ROM, EEPROM, FLASH memory or other memory technology, CD, DVD, or other optical storage, magnetic cassettes, magnetic tape, magnetic disk storage or other magnetic storage devices, or any other media which can be used to store computer-intelligible information and which can be accessed by the computation resource 1302.

Communication media typically embodies computer-readable instructions, data structures, program modules or other data, represented via, and determinable from, a modulated data signal, such as a carrier wave or other transport mechanism, and includes any information delivery media. The term “modulated data signal” means a signal that has one or more of its characteristics set or changed in such a manner as to encode information in the signal in a fashion amenable to computer interpretation.

By way of example, and not limitation, communication media include wired media, such as wired network or direct-wired connections, and wireless media, such as acoustic, RF, infrared and other wireless media. The scope of the term computer-readable media includes combinations of any of the above.

The computer 1302 can function as one or more of the control segments of module 1220 (FIG. 12), the computer 1230, the operator console 1240 and/or the data acquisition and conditioning module 1260, for example, via implementation of the processes of FIGS. 1-8, respectively, as one or more computer program modules.

### CONCLUSION

A clinical-test patient metadata system is described. A technical effect of the systems, methods and apparatus described herein is generation of a mathematical representation of a deviation of patent clinical-test metadata from normal clinical-test metadata. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations. For example, although described in procedural terms, one of ordinary skill in the art will appreciate that implementations can be made in an object-oriented design environment or any other design environment that provides the required relationships.

In particular, one of skill in the art will readily appreciate that the names of the methods and apparatus are not intended to limit embodiments. Furthermore, additional methods and apparatus can be added to the components, functions can be rearranged among the components, and new components to correspond to future enhancements and physical devices used in embodiments can be introduced without departing from the scope of embodiments. One of skill in the art will readily recognize that embodiments are applicable to future communication devices, different file systems, and new data types.

The terminology used in this application is meant to include all medical disease, medical diagnostic, and database environments and alternate technologies which provide the same functionality as described herein.

We claim:

1. A system comprising:
a processor;
a storage device coupled to the processor; and
software apparatus operative on the processor to:
access metadata of a plurality of normal subjects acquired using a plurality of medical tests;
determine normalized and standardized values of the metadata of the plurality of normal subjects acquired using the plurality of medical tests;
determine statistics of the normalized and standardized metadata of normal subjects for each of the plurality of medical tests;
access metadata of a patient acquired using the plurality of medical tests;
determine normalized and standardized values of the metadata of the patient acquired using the plurality of medical tests;
determine at least one deviation between the normal subjects statistics and the patient metadata for each of the plurality of medical tests; and
display a visual representation of deviation for each of the plurality of medical tests.

2. The system of claim 1, wherein the software apparatus operable to determine standardized value further comprises:
software apparatus operable to convert the metadata to a common unit of measurement.

3. The system of claim 1, wherein the software apparatus to determine at least one deviation further comprises:
software apparatus operable to compare normalized and standardized value of each clinical-test label in the patient metadata to a statistics corresponding to a normalized and standardized value of clinical-test label in the normal subject metadata.

4. The system of claim 3, wherein each clinical-test label belongs to a clinical category in the patient metadata.

5. The system of claim 1, wherein the software apparatus to display a visual representation of the plurality of deviations further comprises:
software apparatus operable to generate a Z-score synthetic image of the deviation.

6. A computer-accessible medium having executable instructions to prepare data for visualization, the executable instructions capable of directing a processor to perform:
determining deviations between the normalized and standardized metadata statistics of normal subjects and patient metadata for each of a plurality of medical tests in which each of a plurality of normalized and standardized values of clinical-test labels in the patient metadata is compared to a corresponding normalized and standardized values of clinical-test label statistics in the normal subject metadata; and
generating a Z-score synthetic image of the deviation.

7. The computer-accessible medium of claim 6, the medium further comprising executable instructions capable of directing the processor to perform:
presenting the Z-score synthetic image on a graphical user interface.

8. The computer-accessible medium of claim 6, wherein the executable instructions further comprise executable instructions capable of directing the processor to perform:
accessing metadata of a plurality of normal subjects acquired using a plurality of medical tests;
determining normalized and standardized values of the metadata of the plurality of normal subjects acquired using the plurality of medical tests;
determining statistics of the normalized and standardized metadata of normal subjects for each of the plurality of medical tests;
accessing metadata of a patient acquired using the plurality of medical tests; and
determining normalized and standardized values of the metadata of the patient acquired using the plurality of medical tests.

9. The computer-accessible medium of claim 6, wherein the executable instructions capable of directing the processor to determine standardized values further comprise executable instructions capable of directing the processor to perform:
converting the metadata to a common unit of measurement.

10. The computer-accessible medium of claim 9, wherein the executable instructions capable of directing the processor to determine at least one deviation further comprise executable instructions capable of directing the processor to perform:
determining a deviation metadata vector that describes how far from normalcy is the standardized and normalized patient metadata from the standardized and normalized metadata statistics of normal subject.

11. The computer-accessible medium of claim 10, wherein the executable instructions capable of directing the processor to determine a deviation metadata vector further comprise executable instructions capable of directing the processor to perform:
determining the difference between the standardized and normalized value of the clinical-test label of patient and mean value of the standardized and normalized clinical-test label normal subject, divided by the standard deviation value of the standardized and normalized clinical-test label normal subject.

12. A method to prepare data for visualization, the method comprising:
determining deviations between the normalized and standardized metadata statistics in normal subjects and a patient metadata for each of a plurality of medical tests in which each of a plurality of normalized and standardized values of clinical-test labels in the patient metadata is compared to corresponding normalized and standardized values of clinical-test label statistics in the normal subjects' metadata; and
generating a Z-score synthetic image of deviations.

13. The method of claim 12, the method further comprising:
presenting the Z-score synthetic image on a graphical user interface.

14. The method of claim 12, wherein determining deviations further comprises:
determining a deviation metadata vector that describes how far from normalcy is the standardized and normalized patient metadata from the standardized and normalized metadata statistics of normal subjects.

15. The method of claim 14, wherein determining the deviation metadata vector further comprises:
determining the difference between a label of an axis, divided by the mean of the label of the axis, for each of a plurality of labels.

16. The method of claim 12, wherein determining deviations further comprises:
determining the difference between the standardized and normalized value of the clinical-test label of patient and mean value of the standardized and normalized clinical-test label normal subject, divided by the standard deviation value of the standardized and normalized clinical-test label normal subject.

17. The method of claim 12, the method further comprising:
accessing metadata of a plurality of normal subjects acquired using a plurality of medical tests;
determining normalized and standardized values of the metadata of the plurality of normal subjects acquired using the plurality of medical tests; and
determining statistics of the normalized and standardized metadata of normal subjects for each of the plurality of medical tests.

18. The method of claim 12, the method further comprising:
accessing metadata of a patient acquired using the plurality of medical tests; and
determining normalized and standardized values of the metadata of the patient acquired using the plurality of medical tests.

19. The method of claim 12, wherein the Z-score synthetic image of the deviation further comprises:
an image format representation of Z-scores, wherein each of the plurality of values of clinical-test labels is represented by a particular pixel in the image.

20. The method of claim 12, wherein each clinical-test label belongs to a clinical category in the patient metadata.
